(19) United States
(12) Patent Application Publication
(10) Pub. No.: US 2022/0366381 A1
(43) Pub. Date: Nov. 17, 2022

(54) SYSTEM AND METHOD FOR DISTRIBUTED STORAGE OF TRANSACTIONS

(71) Applicant: CONCEALED NOTARIZED TRANSACTIONAL SYSTEMS SA, Brussels (BE)

(72) Inventors: Olivier GAZON, Brussels (BE); Gerard DETHIER, Esneux (BE)

(21) Appl. No.: 17/640,441

(22) PCT Filed: Sep. 4, 2020
(86) PCT No.: PCT/EP2020/074765

§ 371 Date: Mar. 4, 2022

(30) Foreign Application Priority Data
Sep. 4, 2019 (CH) 01113/19

(51) Int. Cl. G06Q 20/02; G06Q 20/38; H04L 9/40; H04L 9/32

(52) U.S. Cl. CPC G06Q 20/02; G06Q 20/383; G06Q 20/3827; H04L 63/0421; H04L 9/3239

(57) ABSTRACT

For distributed storage of transactions initiated by an account holder, an account device generates and transmits a request for notaries via a communication network to a plurality of custodian devices. The request for notaries includes an open transaction part with non-encrypted transaction data and an anonymized identifier of the account holder, enabling the custodian devices to store the open transaction part linked to the anonymized identifier. The account device receives via the communication network from the custodian devices a set of appointed notary devices. The account device transmits a notarization request via the communication network to the appointed notary devices. The notarization request includes the open transaction part and an encrypted transaction part with encrypted transaction data, enabling the notary devices to store the encrypted transaction part and the open transaction part.

### FIELD OF THE INVENTION

The present invention relates to a computer system and a computer-implemented method for distributed storage of transactions. Specifically, the present invention relates to a computer system and a computer-implemented method for distributed storage of transactions initiated by an account holder.

### BACKGROUND OF THE INVENTION

Distributed ledgers are increasingly being used for storing information from and for many users without having to rely on a central administrator or centralized data storage. A distributed ledger (also called a shared ledger or distributed ledger technology or DLT) is a consensus-based system for replicating, sharing, and synchronizing the storage of digital data geographically spread across multiple devices, sites, countries, and/or institutions. Effectively, distributed ledgers are databases spread across several nodes (devices) on peer-to-peer networks, where each node replicates and saves an identical copy of the ledger and updates itself independently. Without the need for a central authority, consensus is reached by the nodes taking a majority voting about the correct copy of the ledger after updates to the ledger. One form of distributed ledger design is a Blockchain based system, which can be either public or private. Security and authenticity is accomplished through cryptographic keys and signatures. A prominent application of distributed ledgers and Blockchain systems is for storing transactions, for example financial transactions in connection with crypto or fiat currencies. The distributed ledgers ensure immutability by providing cryptography-based algorithms to a network of nodes for validating transactions and detecting and/or preventing any alteration to validated transactions. However, with the increased number of users and applications on the existing distributed ledger and Blockchain systems, some of their shortcomings and limitations have become apparent. Foremost, the increased usage has made it clear that the current systems suffer from poor transaction throughput, high latency, limited possibility for scaling with regards to data volumes and transaction performance, and data privacy issues.

### SUMMARY OF THE INVENTION

It is an object of this invention to provide a computer system and a computer-implemented method for distributed storage of transactions, which computer system and computer-implemented method do not have at least some of the disadvantages of the prior art. In particular, it is an object of the present invention to provide a computer system and a computer-implemented method for distributed storage of transactions, which computer system and computer-implemented method make it possible to scale the system with regards to performance and data volume, while maintaining a distributed nature without a central authority.

According to the present invention, these objects are achieved through the features of the independent claims. In addition, further advantageous embodiments follow from the dependent claims and the description.

According to the present invention, the above-mentioned objects are particularly achieved in that for distributed storage of transactions initiated by an account holder, a computerized account device transmits a request for notaries via a communication network to a plurality of computerized custodian devices. The request for notaries includes an open transaction part, with non-encrypted transaction data of a transaction initiated by the account holder, and an anonymized identifier of the account holder, enabling the computerized custodian devices to store the open transaction part linked to the anonymized identifier. The computerized account device receives via the communication network from the computerized custodian devices a set of computerized notary devices assigned by the computerized custodian devices to the transaction initiated by the account holder. The computerized account device transmits a notarization request via the communication network to the computerized notary devices identified in the set. The notarization request includes the open transaction part with the non-encrypted transaction data and an encrypted transaction part with encrypted transaction data, enabling the computerized notary devices to store the open transaction part and the encrypted transaction part.

Dynamically selecting and appointing notaries by trusted custodians, makes it possible to flexibly and dynamically assign the distributed storage of transactions to different notary devices, thereby distributing the number and volume of transactions over an efficiently and easily scalable number of notary devices.

In an embodiment, for distributed storage of transactions initiated by an account holder, a computerized account device generates a transaction hash by applying a hash function to transaction data of a transaction initiated by the account holder. The transaction data comprises an encrypted transaction part, with encrypted transaction data, and an open transaction part, with non-encrypted transaction data. The computerized account device transmits a request for notaries via a communication network to a plurality of computerized custodian devices. The request for notaries includes the transaction hash, the open transaction part and an anonymized identifier of the account holder, enabling the computerized custodian devices to store the transaction hash and the open transaction part linked to the anonymized identifier. The computerized account device receives via the communication network from the computerized custodian devices a set of computerized notary devices assigned by the computerized custodian devices to the transaction hash. The computerized account device transmits a notarization request via the communication network to the computerized notary devices identified in the set. The notarization request includes the transaction data, enabling the computerized notary devices to store the encrypted transaction part and the open transaction part, and to generate a computed transaction hash for verification with the transaction hash transmitted with the request for notaries.

In an embodiment, the computerized account device transmits a query request via the communication network to the computerized custodian devices. The query request includes a query predicate, a query identifier and the anonymized identifier, enabling the computerized custodian devices to determine for the query request queried transactions, the queried transactions having the transaction hashes linked to the anonymized identifier and to an open transaction part matching the query predicate, and to forward to the computerized notary devices assigned to the queried transactions a query indication. The query indication comprises the query identifier and the transaction hashes determined for the query request. The computerized account device receives via the communication network from the computerized custodian devices the computerized notary devices assigned to the queried transactions. The computerized account device transmits the query identifier via the communication network to the computerized notary devices received from the computerized custodian devices. The computerized account device receives via the communication network from the computerized notary devices the transaction data linked to the transaction hashes, forwarded by the computerized custodian devices for the query request to the computerized notary devices.

In an embodiment, the computerized account device generates a query signature by signing the query request using a private key of the computerized account device. The computerized account device transmits the query signature with the query request to the computerized custodian devices, enabling the computerized custodian devices to authenticate the query request by verifying the query signature using a public key linked to the anonymized identifier.

In an embodiment, the open transaction part comprises a transaction date. The computerized account device includes a query period in the query predicate of the query request, enabling the computerized custodian devices to determine for the query period the transaction hashes linked to the anonymized identifier, and to forward to the computerized notary devices assigned to the anonymized identifier the transaction hashes linked to the anonymized identifier for the query period. The computerized account device receives via the communication network from the computerized custodian devices the transaction hashes and the computerized notary devices assigned to the anonymized identifier for the query period.

In an embodiment, the computerized notary devices confirm storage of the encrypted transaction part by generating a computed transaction hash from the transaction data using the hash function and transmitting the computed transaction hash via the communication network to the computerized custodian devices. The computerized custodian devices generate and transmit via the communication network to the computerized account device a notarization confirmation indicative of successful storage of the transaction by the computerized notary devices, upon verification of the computed transaction hashes received from all computerized notary devices assigned by the respective computerized custodian device.

In an embodiment, the computerized account device receives the encrypted transaction part from an account holder device, determines decrypted transaction data by decrypting the encrypted transaction part, validates the transaction by verifying the decrypted transaction data with regards to coverage by the account holder, and terminates further processing of the transaction upon lack of coverage by the account holder.

In addition to the computer-implemented method for distributed storage of transactions initiated by an account holder, the present invention also relates to a computer system for distributed storage of transactions initiated by an account holder. The computer system comprises one or more processors configured to perform the following steps: transmitting a request for notaries via a communication network to a plurality of computerized custodian devices, the request for notaries including an open transaction part, with non-encrypted transaction data of a transaction initiated by the account holder, and an anonymized identifier of the account holder, enabling the computerized custodian devices to store the open transaction part linked to the anonymized identifier; receiving via the communication network from the computerized custodian devices a set of computerized notary devices assigned by the computerized custodian devices to the transaction initiated by the account holder; and transmitting a notarization request via the communication network to the computerized notary devices identified in the set, the notarization request including the open transaction part with the non-encrypted transaction data and an encrypted transaction part with encrypted transaction data, enabling the computerized notary devices to store the open transaction part and the encrypted transaction part.

In an embodiment, the computer system comprises one or more processors configured to perform the following steps: generating a transaction hash by applying a hash function to transaction data of a transaction initiated by the account holder, the transaction data comprising an encrypted transaction part with encrypted transaction data and an open transaction part with non-encrypted transaction data; transmitting a request for notaries via a communication network to a plurality of computerized custodian devices, the request for notaries including the transaction hash, the open transaction part and an anonymized identifier of the account holder, enabling the computerized custodian devices to store the transaction hash and the open transaction part linked to the anonymized identifier; receiving via the communication network from the computerized custodian devices a set of computerized notary devices assigned by the computerized custodian devices to the transaction hash; and transmitting a notarization request via the communication network to the computerized notary devices identified in the set, the notarization request including the transaction data, enabling the computerized notary devices to store the encrypted transaction part and the open transaction part, and to generate a computed transaction hash for verification with the transaction hash transmitted with the request for notaries.

In an embodiment, the one or more processors are further configured to transmit a query request, which includes a query predicate, a query identifier and the anonymized identifier, via the communication network to the computerized custodian devices, enabling the computerized custodian devices to determine for the query request queried transactions, the queried transactions having the transaction hashes linked to the anonymized identifier and to an open transaction part matching the query predicate, and to forward to the computerized notary devices assigned to the queried transactions a query indication, the query indication comprising the query identifier and the transaction hashes determined for the query request; to receive via the communication network from the computerized custodian devices the computerized notary devices assigned to the queried transactions; to transmit the query identifier via the communication network to the computerized notary devices received from the computerized custodian devices; and to receive via the communication network from the computerized notary devices the transaction data linked to the transaction hashes, forwarded by the computerized custodian devices for the query request to the computerized notary devices.

In an embodiment, the one or more processors are further configured to generate a query signature by signing the query request using a private key of the computerized account device; to transmit the query signature with the query request to the computerized custodian devices, enabling the computerized custodian devices to authenticate the query request by verifying the query signature using a public key linked to the anonymized identifier.

In an embodiment, the open transaction part comprises a transaction date; and the one or more processors are further configured to include a query period in the query predicate of the query request, enabling the computerized custodian devices to determine for the query period the transaction hashes linked to the anonymized identifier, and to forward to the computerized notary devices assigned to the anonymized identifier the transaction hashes linked to the anonymized identifier for the query period; and to receive via the communication network from the computerized custodian devices the transaction hashes and the computerized notary devices assigned to the anonymized identifier for the query period.

In an embodiment, the one or more processors are further configured to receive the encrypted transaction part from an account holder device; to determine decrypted transaction data by decrypting the encrypted transaction part; to validate the transaction by verifying the decrypted transaction data with regards to coverage by the account holder; and to terminate further processing of the transaction upon lack of coverage by the account holder.

In addition to the computer system and the computer-implemented method for distributed storage of transactions initiated by an account holder, the present invention also relates to a computer program product comprising a non-transitory computer-readable medium having stored thereon computer program code configured to control one or more processors of a computer system, such that the computer system performs the following steps: transmitting a request for notaries via a communication network to a plurality of computerized custodian devices, the request for notaries including an open transaction part, with non-encrypted transaction data of a transaction initiated by the account holder, and an anonymized identifier of the account holder, enabling the computerized custodian devices to store the open transaction part linked to the anonymized identifier; receiving via the communication network from the computerized custodian devices a set of computerized notary devices assigned by the computerized custodian devices to the transaction initiated by the account holder; and transmitting a notarization request via the communication network to the computerized notary devices identified in the set, the notarization request including the open transaction part with the non-encrypted transaction data and an encrypted transaction part with encrypted transaction data, enabling the computerized notary devices to store the open transaction part and the encrypted transaction part.

In an embodiment, the computer code is configured to control the one or more processors of the computer system, such that the computer system performs the following steps: generating a transaction hash by applying a hash function to transaction data of a transaction initiated by the account holder, the transaction data comprising an encrypted transaction part with encrypted transaction data and an open transaction part with non-encrypted transaction data; transmitting a request for notaries via a communication network to a plurality of computerized custodian devices, the request for notaries including the transaction hash, the open transaction part and an anonymized identifier of the account holder, enabling the computerized custodian devices to store the transaction hash and the open transaction part linked to the anonymized identifier; receiving via the communication network from the computerized custodian devices a set of computerized notary devices assigned by the computerized custodian devices to the transaction hash; and transmitting a notarization request via the communication network to the computerized notary devices identified in the set, the notarization request including the transaction data, enabling the computerized notary devices to store the encrypted transaction part and the open transaction part, and to generate a computed transaction hash for verification with the transaction hash transmitted with the request for notaries.

In an embodiment, the computer code is further configured to control the one or more processors of the computer system, such that the computer system transmits a query request, which includes a query predicate, a query identifier and the anonymized identifier, via the communication network to the computerized custodian devices, enabling the computerized custodian devices to determine for the query request queried transactions, the queried transactions having the transaction hashes linked to the anonymized identifier and to an open transaction part matching the query predicate, and to forward to the computerized notary devices assigned to the queried transactions a query indication, the query indication comprising the query identifier and the transaction hashes determined for the query request; receives via the communication network from the computerized custodian devices the computerized notary devices assigned to the queried transactions; transmits the query identifier via the communication network to the computerized notary devices received from the computerized custodian devices; and receives via the communication network from the computerized notary devices the transaction data linked to the transaction hashes, forwarded by the computerized custodian devices for the query request to the computerized notary devices.

In an embodiment, the open transaction part comprises a transaction date; and the computer code is further configured to control the one or more processors of the computer system, such that the computer system includes a query period in the query predicate of the query request, enabling the computerized custodian devices to determine for the query period the transaction hashes linked to the anonymized identifier, and to forward to the computerized notary devices assigned to the anonymized identifier the transaction hashes linked to the anonymized identifier for the query period; and receives via the communication network from the computerized custodian devices the transaction hashes and the computerized notary devices assigned to the anonymized identifier for the query period.

In an embodiment, the computer code is further configured to control the one or more processors of the computer system, such that the computer system receives the encrypted transaction part from an account holder device; determines decrypted transaction data by decrypting the encrypted transaction part; validates the transaction by verifying the decrypted transaction data with regards to coverage by the account holder; and terminates further processing of the transaction upon lack of coverage by the account holder.

### BRIEF DESCRIPTION OF THE DRAWINGS

The present invention will be explained in more detail, by way of example, with reference to the drawings in which:

FIGS. 1a,1b: show block diagrams illustrating schematically a computer system connected via a communication network to a plurality of custodian devices and a plurality of notary devices for distributed storage of transactions.

FIG. 2: shows a flow diagram illustrating an exemplary sequence of steps for distributed storage of transactions initiated by an account holder, using a plurality of custodian devices and a plurality of notary devices.

FIG. 3: shows a flow diagram illustrating an exemplary sequence of steps for querying transactions stored on a plurality of notary devices.

### DETAILED DESCRIPTION OF THE PREFERRED EMBODIMENTS

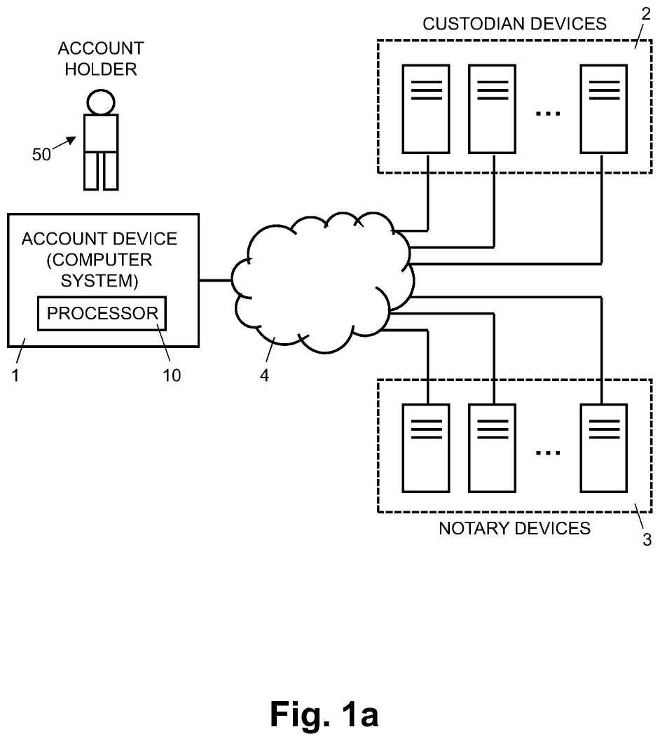

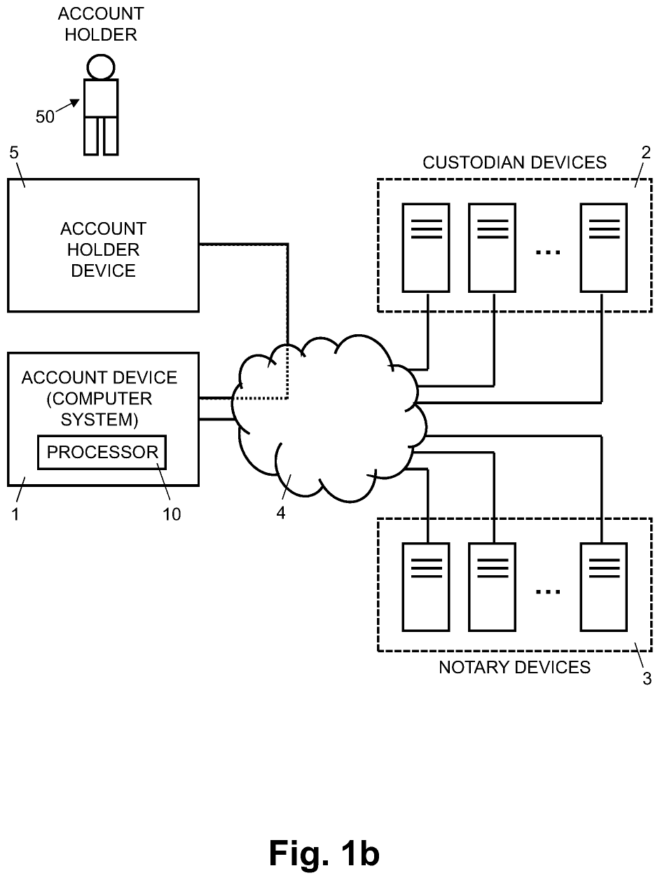

In FIGS. 1a, 1b, 2 and 3, reference numeral 1 refers to an account device. The account device 1 comprises one or more processors 10 configured to perform various functions and steps, as described below in more detail. Depending on the embodiment and/or configuration, the account device 1 comprises a personal computing device, e.g. a personal computer, a mobile radio telephone (smart phone), a tablet computer, or a smart watch, or a computer system including one or more computers with one or more processors 10.

In FIG. 1b, reference numeral 5 refers to an account holder device. The account holder device is a personal computing device comprising one or more processors configured to perform various functions and steps, as described below in more detail. For example, the account holder device 5 comprises a personal computer, a mobile radio telephone (smart phone), a tablet computer, or a smart watch.

In FIGS. 1a, 1b, 2, and 3, reference numeral 2 refers to a plurality of custodian devices. The custodian devices 2 comprise each one or more computers with one or more processors configured to perform various functions and steps, as described below in more detail.

In FIGS. 1a, 1b, 2, and 3, reference numeral 3 refers to a plurality of notary devices. The notary devices 3 comprise each one or more computers with one or more processors configured to perform various functions and steps, as described below in more detail.

In FIGS. 1a and 1b, reference numeral 4 refers to a communication network. The account device 1, the custodian devices 2, the notary devices 3, and the account holder device 5 all comprise a communication module, e.g. an electronic communication circuit and/or a processor, configured for data communication via the communication network 4. Depending on the embodiment and configuration, the communication network 4 comprises Local Area Networks (LAN), Wireless Local Area Networks (WLAN), mobile radio networks, e.g. Global System for Mobile Communication (GSM) networks, Universal Mobile Telephone System (UMTS) networks and/or 5G mobile radio networks, and/or the Internet.

In FIGS. 1a and 1b, reference numeral 50 refers to an account holder.

In the scenario illustrated in FIG. 1a, the account holder 50 uses the account device 1 to interact via the communication network 4 with the custodian devices 2 and the notary devices 3, respectively. In other words, in the scenario illustrated in FIG. 1a, the account holder 50 is a user of the account device 1, directly operating the account device 1.

In the scenario illustrated in FIG. 1b, the account holder 50 uses the account holder device 5 to access the account device 1 via the communication network 4, commanding the account device 1 to interact via the communication network 4 with the custodian devices 2 and the notary devices 3, respectively. In other words, in the scenario illustrated in FIG. 1b, the account holder 50 is a user of the account holder device 5, directly operating the account holder device 5.

As will be explained in more detail, interaction between the account device 1 and the custodian devices 2 and the notary devices 3 comprises data communication (via communication network 4) related to the distributed storage and (respective) querying of transactions initiated by the account holder 50.

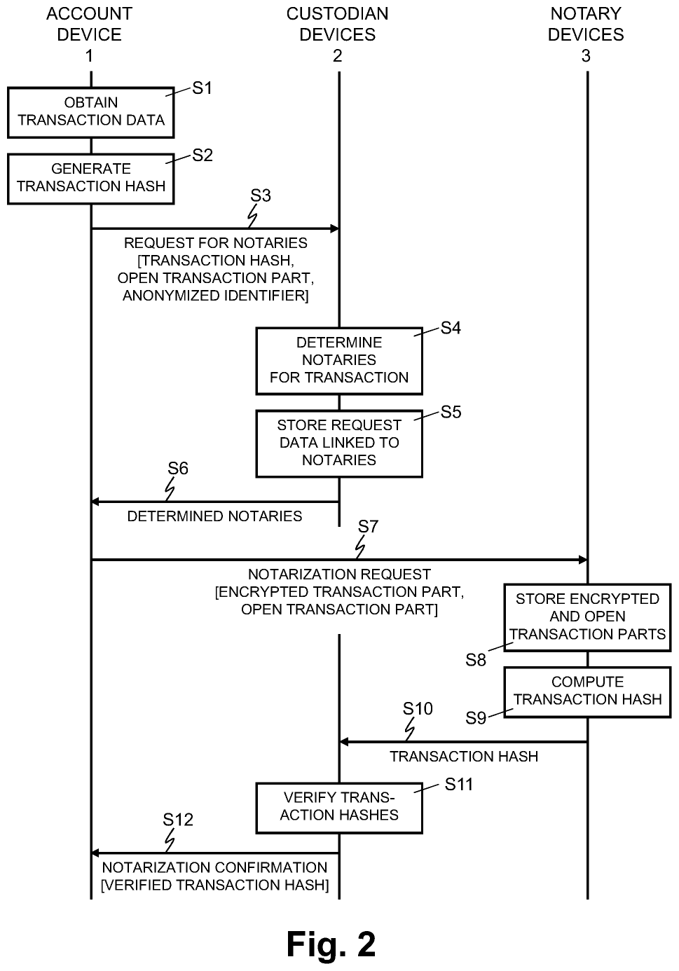

In the following paragraphs, described with reference to FIG. 2 are possible sequences of steps performed by the processors 10 of the account device (computer system) 1 and the processors of the custodian devices 2, the notary devices 3 and the account holder device 5, if applicable, for the distributed storage of transactions initiated by the account holder 50.

In step S1, the account device 1 or its processor 10, respectively, obtains the transaction data related to a transaction initiated and requested by the account holder 50. The transaction request comprises transaction data which includes an encrypted transaction part, with encrypted transaction data, and an open transaction part, with non-encrypted transaction data. The encrypted transaction data comprises sensitive and/or confidential transaction data, e.g. the transaction amount, the recipient and creditor of the transaction, and the account holder 50 as the initiator and debitor of the transaction. The non-encrypted transaction data comprises transaction attributes which make it possible to determine and query the transaction defined in the transaction request. For example, the transaction attributes comprise a transaction date which makes it possible to determine and query transactions using a query predicate for a specific date or period of time. Other transaction attributes include a user specified transaction qualifier, e.g. a purpose of transaction, a type of transaction, a subject of transaction, etc., which makes it possible to determine and query for transactions using query predicates related to a defined transaction qualifier. In an embodiment, the open transaction part further comprises an account holder transaction signature. The account holder transaction signature is generated by cryptographically signing the transaction data, including the encrypted transaction part, with the sensitive and/or confidential transaction data, and the non-encrypted transaction data with the transaction attributes, using a private cryptographic signature key of the account holder 50. The account holder transaction signature makes it possible to verify the authenticity of a transaction being initiated and generated by the account holder 50, using a public cryptographic signature key of the account holder 50.

In the scenario of FIG. 1a, the transaction request and its transaction data (including the account holder transaction signature, if applicable) is generated by a processor 10 of the account device 1, e.g. by a software application used by the account holder 50 and executing on the processor 10 of the account device 1.

In the scenario of FIG. 1b, the transaction request and its transaction data (including the account holder transaction signature, if applicable) is generated by a processor of the account holder device 5, e.g. by a software application used by the account holder 50 and executing on the processor of the account holder device 5.

While in the scenario of FIG. 1a the account device 1 obtains the transaction data from a transaction request generated on the account device 1, in the scenario of FIG. 1b, the account device 1 obtains the transaction data from a transaction request generated by and received from the account holder device 5 per data transmission via the communication network 4.

In the scenario of FIG. 1a, the account device 1 or its processor 10, generates the encrypted transaction part by encrypting the sensitive and/or confidential transaction data, using a secret cryptographic (encryption/decryption) key associated with the account holder 50. Depending on the timing of generating the encrypted transaction part, processing of the sensitive and/or confidential transaction data by the processor 10 of the account device 1 requires (local) access to the non-encrypted sensitive and/or confidential transaction data or decryption of the encrypted transaction part by the processor 10 of the account device 1.

In the scenario of FIG. 1b, prior to transmission, the encrypted transaction part is generated by the account holder device 5 or its processor, respectively, encrypting the sensitive and/or confidential transaction data, using the secret cryptographic (encryption/decryption) key associated with the account holder 50 and shared with the account device 1. Accordingly, in the scenario of FIG. 1b, the account device 1 or its processor 10, respectively, obtains the sensitive and/or confidential transaction data by decrypting the encrypted transaction part received from the account holder device 5, using the secret cryptographic (encryption/decryption) key associated with the account holder device 5.

In an embodiment, prior to further processing the obtained transaction data, the account device 1 or its processor 10, respectively, validates the transaction request by checking whether the transaction amount defined in the sensitive and/or confidential transaction data is covered by the account holder 50 or its account, respectively. Upon lack of coverage, further processing of the transaction data is terminated and a negative notification message is generated and provided (transferred and/or displayed) to the account holder 50. Otherwise, if the requested transaction amount is covered, further processing of the transaction request and the transaction data continues in step S2.

In step S2, the account device 1 or its processor 10, respectively, generates a transaction hash by applying a cryptographic hash function to the transaction data, including the encrypted transaction part and the open transaction part. A cryptographic hash function is a mathematical one-way function, i.e. a function which is practically infeasible to invert, which generates from given input data output data, e.g. a bit string of a fixed size, referred to as the “hash” of the input data.

In step S3, the account device 1 or its processor 10, respectively, generates and transmits via the communication network 4 to a plurality of custodian devices 2 a request for notaries. The request for notaries is related to the particular transaction and comprises the transaction hash, the open transaction part with the non-encrypted transaction data, and an anonymized identifier of the account holder 50 who initiated and requested the transaction. For example, the anonymized identifier of the account holder 50 is generated by the account device 1 or its processor 10, respectively, based on a local and secret mapping of a non-anonymized identifier of the account holder 50 to a unique identifier, used as the anonymized identifier for the account holder 50. Depending on the embodiment and/or configuration, the request for notaries is transmitted to all custodian devices 2.

In step S4, the custodian devices 2 receive the request for notaries and determine a set of notary devices 3. The notary devices 3 are defined by notary identifiers, e.g. a unique number, code, and/or a communication address. The notary devices 3 are selected and appointed for notarization of the transaction referenced in the request for notaries. For example, the appointment of the notary devices 3 is executed by the custodian devices 2 using a random process or another statistically balanced selection algorithm for selecting the set of appointed notary devices 3 from a larger pool of registered and authorized (approved) notary devices 3. Preferably, a new set of notaries is selected for every transaction initiated by an account holder. In an embodiment, once appointed, the same notaries or notarization devices 3, respectively, are used for notarization of more than one transactions for a particular anonymized identifier of an account holder 50, however, only for a limited period of time, such as to prevent collusion and alterations of stored transactions by a set of notaries which are appointed to a given account holder on a permanent basis or for a long period of time.

In step S5, the custodian devices 2 store notary records for the notary devices 3 selected and appointed for notarization of the transaction referenced in the request for notaries. More specifically, as illustrated schematically in Table 1, the custodian devices 2 store notary records comprising identifiers ND1, ND2, NDn of the selected notary devices 3 linked to the transaction hash TH1, TH2, TH3, THq-1, THq, the open transaction part with the transaction attributes, and the anonymized identifier AH1, AHm of the account holder 50 who initiated and requested the transaction, as received in the respective request for notaries. Accordingly, the notaries or their notary devices 3, respectively, selected and appointed for notarization of a particular transaction can be determined based on query predicates such as the transaction attributes included in the open transaction part, the anonymized identifier of the account holder 50, and/or the transaction hash related to the transaction.

TABLE 1

| Account | Transaction | | |
|---|---|---|---|
| holder | hash | Transaction attributes | Notary devices |
| AH1 | TH1 | Transaction date, | ND1, ND2, . . . , NDn |
| | | transaction qualifier(s) | |
| AH1 | TH2 | Transaction date, | ND1, ND2, . . . , NDn |
| | | transaction qualifier(s) | |
| AH1 | TH3 | Transaction date, | ND1, ND2, . . . , NDn |
| | | transaction qualifier(s) | |
| . . . | . . . | . . . | . . . |
| AHm | THq-1 | Transaction date, | ND1, ND2, . . . , NDn |
| | | transaction qualifier(s) | |
| AHm | THq | Transaction date, | ND1, ND2, . . . , NDn |
| | | transaction qualifier(s) | |

In step S6, the custodian devices 2 transmit the set of appointed notary devices 3 or their identifiers, respectively, to the requesting account device 1.

In step S7, upon receiving from—all or a qualified majority of—the addressed custodian devices 2 the same set of appointed notary devices 3, the account device 1 generates and transmits to the appointed notary devices 3 a notarization request for the transaction.

The notarization request comprises the transaction data, including the encrypted transaction part, with the encrypted transaction data, and the open transaction part, with the non-encrypted transaction data.

In step S8, upon receiving the notarization request for the transaction from the account device 1, the notary devices 3 store the transaction data with the encrypted transaction part and the non-encrypted transaction data.

In step S9, the notary devices 3 compute the transaction hash by applying the cryptographic hash function to the transaction data, including the encrypted transaction part and the open transaction part.

In step S10, the notary devices 3 transmit the computed transaction hash via the communication network 4 to all the custodian devices 2. In an embodiment, the appointed notary devices 3 are informed by the appointing custodian device 2 about their appointment as notaries for a particular transaction, as defined by the respective transaction hash, and the notary devices 3 transmit the computed transaction hash via the communication network 4 to the appointing custodian devices 2, i.e. to the custodian devices 2 from which they received a notification of their appointment as notaries for a particular transaction.

In step S11, the custodian devices 2 verify the transaction hashes received from the notary devices 3, by comparing the transaction hashes received from the notary devices 3 to the transaction hashes stored at the custodian devices 2.

In step S12, upon positive verification of the transaction hashes, the custodian devices 2 transmit to the account device 1 a notarization confirmation, including the positively verified transaction hash. Depending on the embodiment and/or configuration, the notarization confirmation is conditioned on a response and positive verification of the transaction hash from all appointed notary devices 3 or from a qualified majority, i.e. defined minimum ratio, of the appointed notary devices 3.

In the scenario of FIG. 1b, the account device 1 or its processor 10, respectively, confirms the successful validation and notarization of the transaction to the account holder 50 or its account holder device 5, respectively, e.g. by way of a notarization confirmation message.

It is pointed out here, that it is possible for the account device 1 or its processor 10, or for the account holder device 5 or its processor, respectively, to verify the successful validation and notarization of the transaction by generating a respective transaction query, as will be described in the following paragraphs.

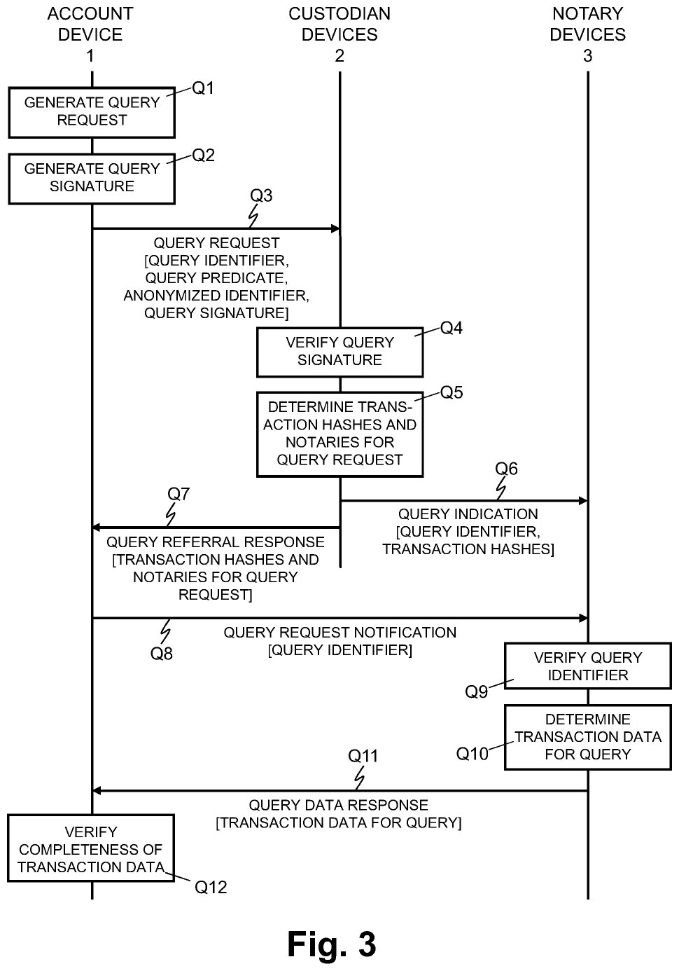

In the following paragraphs, described with reference to FIG. 3 are possible sequences of steps performed by the processors 10 of the account device (computer system) 1 and the processors of the custodian devices 2, the notary devices 3 and the account holder device 5, if applicable, for querying transactions initiated by the account holder 50 and stored in a distributed fashion as described above with reference to FIG. 2.

In step Q1, the account device 1 or its processor 10 (or the account holder device 5 or its processor), respectively, generates a query request for querying a particular transaction or a defined set of transactions stored by the notary devices 3. The query request relates to and specifies the transactions to be queried. The query request may be responsive to a request and query predicates received from the account holder 50, or it may be initiated automatically by the account device 1 or its processor 10, respectively, e.g. subsequently to execution of a notarization request to verify the successful validation and notarization of the transaction. The query request comprises a query identifier, one or more query predicates, and an anonymized identifier of the account holder 50 concerned. The query predicates relate to the transaction attributes included in the non-encrypted transaction data of the open transaction part. For example, the query predicates include a specific date, a period of time, and/or other transaction attributes, such as one or more user specified transaction qualifiers, e.g. a purpose of transaction, a type of transaction, a subject of transaction, etc., for defining one or more notarized transactions to be queried. In an embodiment, the query request further comprises an account holder query signature.

In step Q2, the account holder query signature is generated by the account device 1 or its processor 10 (or the account holder device 5 or its processor), respectively, cryptographically signing the query data, including the query identifier, the query predicates, and the anonymized identifier, using the private cryptographic signature key of the account holder 50. The account holder query signature makes it possible to verify authenticity of a query being initiated and generated for the account holder 50, using a public cryptographic signature key of the account holder 50.

In step Q3, the account device 1 or its processor 10 (or the account holder device 5 or its processor), respectively, transmits the query request via the communication network 4 to (all) the custodian devices 2.

In step Q4, the custodian devices 2 verify authenticity of the query request by verifying the account holder query signature, using the public signature key of the account holder 50 which is assigned to the anonymized identifier.

In step Q5, upon positive verification of the account holder query signature, the custodian devices 2 determine the notary records which match the received query. The matching notary records relate to the queried transactions. More specifically, the custodian devices 2 or their processors, respectively, determine the notaries or notary devices 3, respectively, and assigned transaction hashes which are linked to the anonymized identifier included in the query request and which are linked to an open transaction part comprising transaction attributes matching the query predicates included in the query request, for example, a transaction date equal to a date defined by the query predicates or within a time period specified by the query predicates, and/or transaction qualifiers matching the query predicates.

In step Q6, the custodian devices 2 generate and transmit via the communication network 4 to the determined notary devices 3 a query indication. The query indication comprises the query identifier of the query request and the determined transaction hashes which match the query request. The matching transaction hashes relate to the queried transactions.

In step Q7, the custodian devices 2 generate and transmit via the communication network 4 to the account device 1 (or the account holder device 5), a query referral response. The query referral response comprises and/or relates to the query identifier of the query request. The query referral response comprises the determined identifiers of the notaries or notary devices 3, respectively, and the transaction hashes which match the query request.

In step Q8, the account device 1 or its processor 10 (or the account holder device 5 or its processor), respectively, transmit via the communication network 4 to the determined notary devices 3 a query request notification. The query request notification comprises the query identifier of the query request.

In step Q9, the notary devices 3 or their processors, respectively, verify the query identifier received in the query request notification, by comparing it to the query identifier received in the query indication from the custodian devices 2.

In step Q10, upon positive verification of the query identifier, the notary devices 3 or their processors, respectively, determine the transaction data stored for the transaction hashes received for the query identifier with the query notification from the custodian devices 2.

In step Q11, the notary devices 3 or their processors, respectively, transmit via the communication network to the account device 1 (or the account holder device 5), a query data response. The query data response comprises and/or refers to the query identifier of the query request. The query data response comprises the determined transaction data, including the encrypted transaction data and the non-encrypted transaction data.

In step Q12, the account device 1 or its processor 10 (or the account holder device 5 or its processor), respectively, verifies the completeness of the received transaction data. More specifically, the account device 1 or its processor 10 (or the account holder device 5 or its processor), respectively, verify that the transaction data was received from the notary devices 3 for all the transaction hashes included by the custodian devices 2 in the query referral response.

It should be noted that, in the description, the sequence of the steps has been presented in a specific order, one skilled in the art will understand, however, that the order of at least some of the steps could be altered, without deviating from the scope of the invention as claimed.

1. A computer-implemented method for distributed storage of transactions initiated by an account holder, the method comprising:
transmitting, by a computerized account device, a request for notaries via a communication network to a plurality of computerized custodian devices, the request for notaries including an open transaction part, with non-encrypted transaction data of a transaction initiated by the account holder, and an anonymized identifier of the account holder, enabling the computerized custodian devices to store the open transaction part linked to the anonymized identifier;
receiving, by the computerized account device, via the communication network from the computerized custodian devices a set of computerized notary devices assigned by the computerized custodian devices to a transaction initiated by the account holder; and
transmitting, by the computerized account device, a notarization request via the communication network to the computerized notary devices identified in the set, the notarization request including the open transaction part with the non-encrypted transaction data and an encrypted transaction part with encrypted transaction data, enabling the computerized notary devices to store the open transaction part and the encrypted transaction part.

2. The method of claim 1, further comprising:
generating, by the computerized account device, a transaction hash by applying a hash function to transaction data of the transaction initiated by the account holder, the transaction data comprising the encrypted transaction part with the encrypted transaction data and the open transaction part with the non-encrypted transaction data;
wherein the request for notaries further including the transaction hash, enabling the computerized custodian devices to store the transaction hash and the open transaction part linked to the anonymized identifier,
wherein the receiving, by the computerized account device, the set of computerized notary devices includes receiving the set of computerized notary devices assigned by the computerized custodian devices to the transaction hash linked to the anonymized identifier;
wherein the transmitting, by the computerized account device, the notarization request to the computerized notary devices includes transmitting the notarization request to the computerized notary device enabling the computerized notary devices to generate a computed transaction hash for verification with the transaction hash transmitted with the request for notaries.

3. The method of claim 2, further comprising:
transmitting, by the computerized account device, a query request, which includes a query predicate, a query identifier, and the anonymized identifier, via the communication network to the computerized custodian devices, enabling the computerized custodian devices to determine for the query request queried transactions, the queried transactions having the transaction hashes linked to the anonymized identifier and to an open transaction part matching the query predicate, and to forward to the computerized notary devices assigned to the queried transactions a query indication, the query indication comprising the query identifier and the transaction hashes determined for the query request;
receiving, by the computerized account device via the communication network from the computerized custodian devices, the computerized notary devices assigned to the queried transactions;
transmitting, by the computerized account device, the query identifier via the communication network to the computerized notary devices received from the computerized custodian devices; and
receiving, by the computerized account device via the communication network from the computerized notary devices, the transaction data linked to the transaction hashes, forwarded by the computerized custodian devices for the query request to the computerized notary devices.

4. The method of claim 3, further comprising:
generating, by the computerized account device, a query signature by signing the query request using a private key of the computerized account device;
transmitting, by the computerized account device, the query signature with the query request to the computerized custodian devices, enabling the computerized custodian devices to authenticate the query request by verifying the query signature using a public key linked to the anonymized identifier.

5. The method of claim 3,
wherein the open transaction part comprises a transaction date,
wherein the query predicate includes a query period, enabling the computerized custodian devices to determine for the query period the transaction hashes linked to the anonymized identifier, and to forward to the computerized notary devices assigned to the anonymized identifier the transaction hashes linked to the anonymized identifier for the query period, the method further comprising:
receiving, by the computerized account device via the communication network from the computerized custodian devices, the transaction hashes and the computerized notary devices assigned to the anonymized identifier for the query period.

6. The method of claim 2, further comprising:
confirming, by the computerized notary devices, storage of the encrypted transaction part by generating a computed transaction hash from the transaction data using the hash function and transmitting the computed transaction hash via the communication network to the computerized custodian devices; and
generating and transmitting, by the computerized custodian devices via the communication network to the computerized account device, a notarization confirmation indicative of successful storage of the transaction by the computerized notary devices, upon verification of the computed transaction hashes received from all computerized notary devices assigned by the respective computerized custodian device.

7. The method of claim 1, further comprising:
receiving, by the computerized account device, the encrypted transaction part from an account holder device;
determining decrypted transaction data by decrypting the encrypted transaction part;
validating the transaction by verifying the decrypted transaction data with regards to coverage by the account holder; and
terminating further processing of the transaction upon lack of coverage by the account holder.

8. A computer system for distributed storage of transactions initiated by an account holder, the computer system comprising one or more processors configured to perform:
transmitting a request for notaries via a communication network to a plurality of computerized custodian devices, the request for notaries including an open transaction part, with non-encrypted transaction data of a transaction initiated by the account holder, and an anonymized identifier of the account holder, enabling the computerized custodian devices to store the open transaction part linked to the anonymized identifier;
receiving via the communication network from the computerized custodian devices a set of computerized notary devices assigned by the computerized custodian devices to the transaction initiated by the account holder; and
transmitting a notarization request via the communication network to the computerized notary devices identified in the set, the notarization request including the open transaction part with the non-encrypted transaction data and an encrypted transaction part with encrypted transaction data, enabling the computerized notary devices to store the open transaction part and the encrypted transaction part.

9. The computer system of claim 8, wherein the one or more processors are further configured:
to generate a transaction hash by applying a hash function to transaction data of the transaction initiated by the account holder, the transaction data comprising the encrypted transaction part with the encrypted transaction data and the open transaction part with the non-encrypted transaction data;
to transmit the request for notaries further including the transaction hash, enabling the computerized custodian devices to store the transaction hash and the open transaction part linked to the anonymized identifier;
to receive the set of computerized notary devices assigned by the computerized custodian devices to the transaction hash linked to the anonymized identifier; and
to transmit the notarization request to the computerized notary devices enabling the computerized notary devices to generate a computed transaction hash for verification with the transaction hash transmitted with the request for notaries.

10. The computer system of claim 8, wherein the one or more processors are further configured;
to transmit a query request, which includes a query predicate, a query identifier and the anonymized identifier, via the communication network to the computerized custodian devices, enabling the computerized custodian devices to determine for the query request queried transactions, the queried transactions having the transaction hashes linked to the anonymized identifier and to an open transaction part matching the query predicate, and to forward to the computerized notary devices assigned to the queried transactions a query indication, the query indication comprising the query identifier and the transaction hashes determined for the query request;
to receive via the communication network from the computerized custodian devices the computerized notary devices assigned to the queried transactions;
to transmit the query identifier via the communication network to the computerized notary devices received from the computerized custodian devices; and
to receive via the communication network from the computerized notary devices the transaction data linked to the transaction hashes, forwarded by the computerized custodian devices for the query request to the computerized notary devices.

11. The computer system of claim 10, wherein the one or more processors are further configured:
to generate a query signature by signing the query request using a private key of the computerized account device;
to transmit the query signature with the query request to the computerized custodian devices, enabling the computerized custodian devices to authenticate the query request by verifying the query signature using a public key linked to the anonymized identifier.

12. The computer system of claim 10, wherein the open transaction part comprises a transaction date; and the one or more processors are further configured:
to include a query period in the query predicate of the query request, enabling the computerized custodian devices to determine for the query period the transaction hashes linked to the anonymized identifier, and to forward to the computerized notary devices assigned to the anonymized identifier the transaction hashes linked to the anonymized identifier for the query period; and
to receive via the communication network from the computerized custodian devices the transaction hashes and the computerized notary devices assigned to the anonymized identifier for the query period.

13. The computer system of claim 8, wherein the one or more processors are further configured:
to receive the encrypted transaction part from an account holder device;
to determine decrypted transaction data by decrypting the encrypted transaction part;
to validate the transaction by verifying the decrypted transaction data with regards to coverage by the account holder; and
to terminate further processing of the transaction upon lack of coverage by the account holder.

14. A computer program product comprising a non-transitory computer-readable medium having stored thereon computer code configured to control one or more processors of a computer system, such that the computer system performs:
transmitting a request for notaries via a communication network to a plurality of computerized custodian devices, the request for notaries including an open transaction part, with non-encrypted transaction data of a transaction initiated by the account holder, and an anonymized identifier of the account holder, enabling the computerized custodian devices to store the open transaction part linked to the anonymized identifier;
receiving via the communication network from the computerized custodian devices a set of computerized notary devices assigned by the computerized custodian devices to the transaction initiated by the account holder; and
transmitting a notarization request via the communication network to the computerized notary devices identified in the set, the notarization request including the open transaction part with the non-encrypted transaction data and an encrypted transaction part with encrypted transaction data, enabling the computerized notary devices to store the open transaction part and the encrypted transaction part.

15. The computer program product of claim 14, wherein the computer code is further configured to control the one or more processors of the computer system, such that the computer system generates a transaction hash by applying a hash function to transaction data of the transaction initiated by the account holder, the transaction data comprising the encrypted transaction part with the encrypted transaction data and the open transaction part with the non-encrypted transaction data,
wherein the request for notaries further including the transaction hash, enabling the computerized custodian devices to store the transaction hash and the open transaction part linked to the anonymized identifier,
wherein the receiving the set of computerized notary devices includes receiving the set of computerized notary devices assigned by the computerized custodian devices to the transaction hash linked to the anonymized identifier,
wherein the transmitting the notarization request to the computerized notary devices includes transmitting the notarization request to the computerized notary devices enabling the computerized notary devices to generate a computed transaction hash for verification with the transaction hash transmitted with the request for notaries.

16. The computer program product of one claim 15, wherein the computer code is further configured to control the one or more processors of the computer system, such that the computer system:
transmits a query request, which includes a query predicate, a query identifier and the anonymized identifier, via the communication network to the computerized custodian devices, enabling the computerized custodian devices to determine for the query request queried transactions, the queried transactions having the transaction hashes linked to the anonymized identifier and to an open transaction part matching the query predicate, and to forward to the computerized notary devices assigned to the queried transactions a query indication, the query indication comprising the query identifier and the transaction hashes determined for the query request;
receives via the communication network from the computerized custodian devices the computerized notary devices assigned to the queried transactions;
transmits the query identifier via the communication network to the computerized notary devices received from the computerized custodian devices; and
receives via the communication network from the computerized notary devices the transaction data linked to the transaction hashes, forwarded by the computerized custodian devices for the query request to the computerized notary devices.

17. The computer program product of claim 16, wherein the open transaction part comprises a transaction date and the computer code is further configured to control the one or more processors of the computer system, such that the computer system:
includes a query period in the query predicate of the query request, enabling the computerized custodian devices to determine for the query period the transaction hashes linked to the anonymized identifier, and to forward to the computerized notary devices assigned to the anonymized identifier the transaction hashes linked to the anonymized identifier for the query period; and
receives via the communication network from the computerized custodian devices the transaction hashes and the computerized notary devices assigned to the anonymized identifier for the query period.

18. The computer program product of one of claim 14, wherein the computer code is further configured to control the one or more processors of the computer system, such that the computer system:
receives the encrypted transaction part from an account holder device;
determines decrypted transaction data by decrypting the encrypted transaction part;
validates the transaction by verifying the decrypted transaction data with regards to coverage by the account holder; and
terminates further processing of the transaction upon lack of coverage by the account holder.
